(19) United States
(12) Patent Application Publication
(10) Pub. No.: US 2007/0182366 A1
(43) Pub. Date: Aug. 9, 2007

(54) Detecting a battery within a battery charger

(76) Inventor: Won-Woo Lee, Seoul (KR)

Correspondence Address: LAW OFFICE OF MONICA H CHOI, P O BOX 3424, DUBLIN, OH, 430160204, US

(21) Appl. No.: 11/653,559

(22) Filed: Jan. 16, 2007

(30) Foreign Application Priority Data
Feb. 1, 2006 (KR) 2006-09550

(51) Int. Cl. H02J 7/00

(52) U.S. Cl. 320/107

(57) ABSTRACT

A device for detecting a battery within a charger includes a battery detector and a regulation voltage controller that limits a battery charging terminal voltage to a battery regulation voltage. The battery detector generates a battery existence signal if a battery charging terminal voltage is not greater than a battery detection reference voltage at an end of a predetermined time period. The battery charging terminal voltage is limited to a normal mode value of the battery regulation voltage if the battery existence signal is generated. The battery detector also detects for removal of the battery after the battery regulation voltage is set to the normal mode value during charging.

### BACKGROUND OF THE INVENTION

This application claims priority to Korean Patent Application No. 2006-09550, filed on Feb. 1, 2006 in the Korean Intellectual Property Office, the disclosure of which is incorporated herein in its entirety by reference.

1. Field of the Invention

The present invention relates generally to battery technology, and more particularly to a method and device for detecting existence/non-existence of a battery within a battery charger.

2. Background of the Invention

Mobile apparatuses such as notebooks, digital camcorders, digital cameras, cell phones, etc. are being increasingly used. A power source system included in a mobile apparatus uses a battery for stably providing the mobile apparatus with power, especially when a power adapter is not used. Some batteries for the power source system of the mobile apparatus are recharged by a charger, and such batteries are referred to as a secondary battery.

An indication of the existence/non-existence of a battery within a battery charger may be useful. For example, the indication of the existence/non-existence of the battery is used for turning on/off a light emitting diode (LED), which informs a user of whether the battery is correctly connected to the charger. Additionally, the indication about the existence/non-existence of the battery is used for controlling a charger to run on low power when a battery is connected to the battery charging terminal.

Generally, an additional external device or pin is used for detecting the existence/non-existence of a battery. A conventional charger using the above method may determine a battery as being connected to a battery charging terminal even though the battery is not correctly connected to the battery charging terminal. Additionally, such a conventional charger may not provide a user with accurate indication about whether a battery is correctly connected to the battery charging terminal. Further, the manufacturing cost for the charger may be increased due to the use of the additional external device or pin.

FIG. 1 is a circuit diagram illustrating an example conventional charge control system 100 with a mechanism for detecting the existence/non-existence of a battery, which is disclosed in U.S. Pat. No. 6,340,876. Referring to FIG. 1, the charge control system 100 includes a battery removal detection circuit 10, a charger 102, and a state machine 104. The battery removal detection circuit 10 supplies a control signal NO_BAT to the state machine 104 using only two sensing nodes 106 and 108.

A battery charger may be configured to operate in a dual mode including a constant current mode and a constant voltage mode. A battery may be charged initially in the constant current mode, in which a charge current is maintained. In the constant current mode, a battery voltage is increased as the battery is gradually charged. Accordingly, a charge voltage in the constant current mode is increased to maintain the charge current. When the battery voltage approaches a predetermined voltage, the battery may be charged in the constant voltage mode, in which the charge voltage is maintained but the charge current is varied. The constant voltage mode may be used to prevent a voltage drop due to a leakage current of the battery that has been charged substantially to the predetermined voltage.

The battery removal detection circuit 10 in FIG. 1 may detect the non-existence of the battery without an additional external device or pin. However, the battery removal detection circuit 10 can be used only in a constant current mode since the battery removal detection circuit 10 uses a signal Δ GONE, which depends on change of a current I_{IN} flowing into the charger 102, for determining the existence/non-existence of a battery. Thus, the battery removal detection circuit 10 may not detect the existence/non-existence of a battery in a constant voltage mode in which the charging current can be varied when a battery 150 has been charged substantially to a predetermined voltage.

### SUMMARY OF THE INVENTION

Accordingly, embodiments of the present invention determine existence/non-existence of a battery without using an additional external device or pin and during an initial charging of a battery and detect for removal of the battery during later charging of the battery.

A device for detecting a battery within a charger according to an embodiment of the present invention includes a regulation voltage controller and a battery detector. The regulation voltage controller limits a battery charging terminal voltage to a battery regulation voltage that is initially set to a test mode value. The battery detector generates a battery existence signal if a battery charging terminal voltage is not greater than a battery detection reference voltage at an end of a predetermined time period from a power-on of the charger. The regulation voltage controller limits the battery charging terminal voltage to the battery regulation voltage set to a normal mode value if the battery existence signal is generated.

In another embodiment of the present invention, the battery detector generates a battery non-existence signal if the battery charging terminal voltage is greater than the battery detection reference voltage at the end of the predetermined time period.

In a further embodiment of the present invention, the battery detector detects for removal of the battery after the battery regulation voltage is set to the normal mode value. For example, a reset unit detects an irregular time point when the battery charging terminal voltage becomes greater than the battery detection reference voltage. In that case, the battery detector generates a battery non-existence signal if the battery charging terminal voltage is greater than the battery detection reference voltage at the end of the predetermined time period from the irregular time point.

In an example embodiment of the present invention, the test mode value is greater than the normal mode value for the battery regulation voltage. In addition, the battery detection reference voltage is higher than the normal mode value of the battery regulation voltage and lower than a high power source voltage.

For determining the predetermined time period, an oscillator generates an oscillation signal. A counter counts the oscillation signal a predetermined number of cycles. A detection period determiner activates a detection termination signal after the oscillation signal is counted the predetermined number of cycles for indicating the end of the predetermined time period.

The battery charger including such a device for determining the existence/non-existence of the battery includes a current feed-back loop for controlling a level of a current flowing to the battery charging terminal depending on the battery regulation voltage.

In this manner, the existence/non-existence of the battery is determined upon power-on of the charger, and the removal of the battery is detected during a charging of the battery with the battery regulation voltage set to the normal mode value.

### BRIEF DESCRIPTION OF THE DRAWINGS

The above and other features and advantages of the present invention will become more apparent when described in detailed exemplary embodiments thereof with reference to the attached drawings in which:

FIG. 1 is a circuit diagram of a conventional device for detecting existence/non-existence of a battery;

FIG. 2 is a circuit diagram of a battery charger capable of detecting existence/non-existence of a battery, according to an embodiment of the present invention;

FIG. 3 is a block diagram of a battery detector in FIG. 2, according to an embodiment of the present invention;

FIGS. 4A, 4B and 4C are circuit diagrams of a detection period determiner, a detection signal generator, and a reset unit, respectively, in FIG. 3, according to an embodiment of the present invention;

FIG. 5 is a circuit diagram of a regulation voltage controller in FIG. 2, according to an embodiment of the present invention;

FIG. 6 is a timing diagram of signals in the battery charger of FIG. 2 for detecting non-existence of a battery, according to an embodiment of the present invention;

FIG. 7 is a timing diagram of signals in the battery charger of FIG. 2 for detecting existence of a battery, according to an embodiment of the present invention;

FIG. 8 is a timing diagram of signals in the battery charger of FIG. 2 for detecting removal of the battery during charging, according to an embodiment of the present invention; and

FIG. 9 is a flow chart of steps during operation of the battery charger of FIG. 2, according to an embodiment of the present invention.

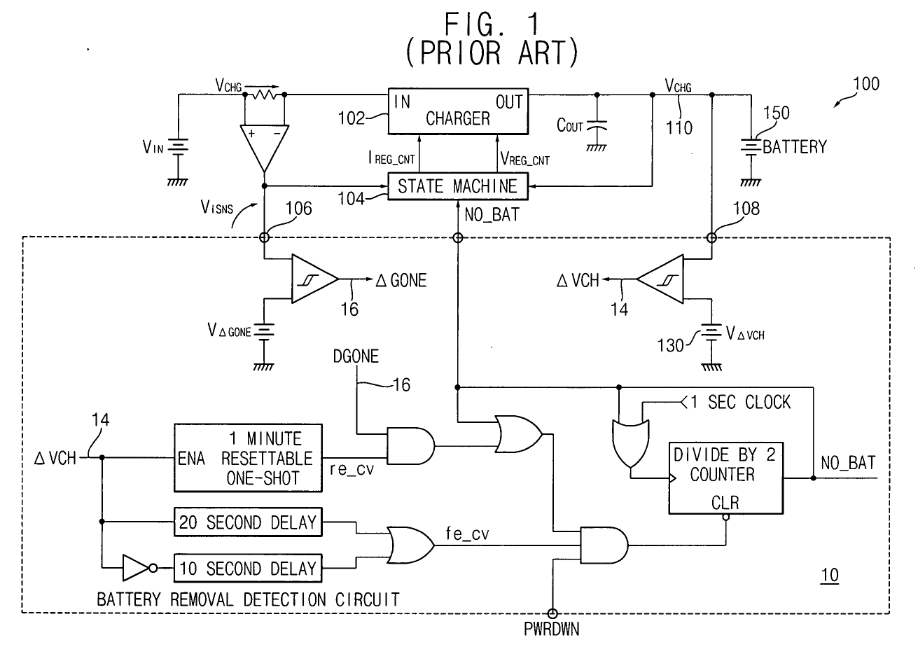

The figures referred to herein are drawn for clarity of illustration and are not necessarily drawn to scale. Elements having the same reference numerals in FIGS. 1, 2, 3, 4, 5, 6, 7, 8, and 9 refer to elements having similar structure and/or function.

### DETAILED DESCRIPTION OF THE INVENTION

Embodiments of the present invention will now be described more fully with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

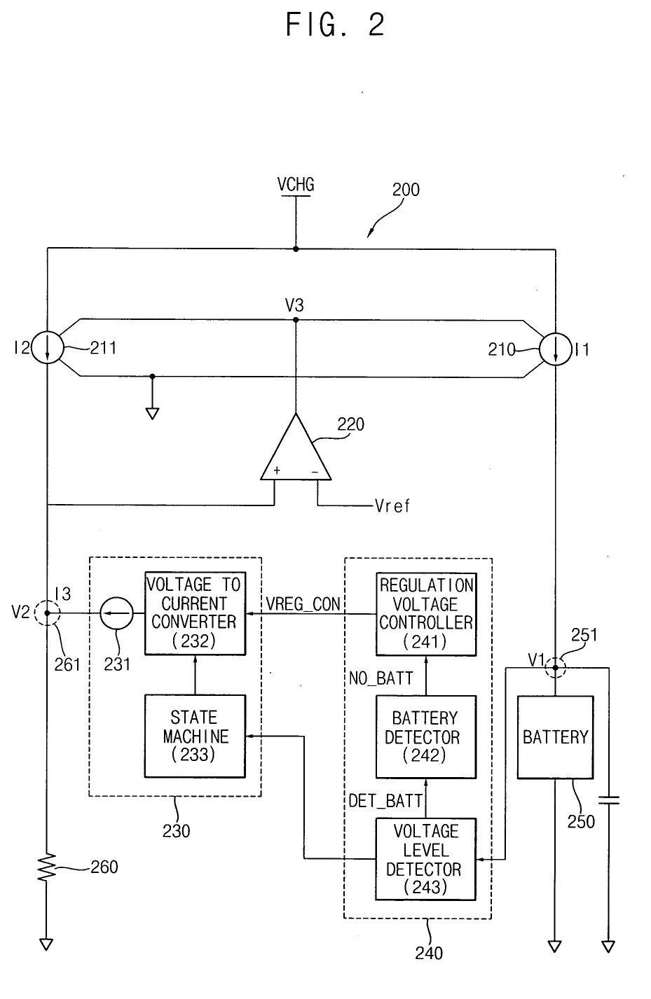

FIG. 2 is a circuit diagram of a battery charger 200 capable of detecting existence/non-existence of a battery according to an embodiment of the present invention. Referring to FIG. 2, the battery charger 200 includes a first current source 210, a second current source 211, an amplifier 220, a charge voltage regulator 230, a device 240 for detecting existence/non-existence of a battery, and a load resistor 260.

The first current source 210 supplies a battery 250, which is connected to a battery charging terminal 251, with a first current, i.e., a charge current I1. Such a charge current I1 flowing to the battery charging terminal 251 charges the battery 250. The second current source 211 is coupled to the first current source 210 as a current mirror. Thus, when a second current I2 generated by the second current source 211 decreases, the first current I1 generated by the first current source 210 also decreases. Additionally, when the second current I2 generated by the second current source 211 increases, the first current I1 generated by the first current source 210 also increases.

The amplifier 220 controls the level of the first and second currents I1 and I2 generated by the first and second current sources 210 and 211, which are coupled to each other as a current mirror. A reference voltage Vref is applied at a negative input of the amplifier 220. A load terminal voltage V2 generated at a load terminal 261 between the load resistor 260 and the second current source 211 is applied at a positive input of the amplifier 220. The amplifier 220 amplifies a difference between such voltages Vref and V2 to output an amplified difference.

In an example embodiment of the present invention, when the second current I2 of the second current source 211 increases, the load terminal voltage V2 increases. When the load terminal voltage V2 increases, a third voltage V3 that is an output of the amplifier 220 increases. The second current I2 of the second source 211 is designed to decrease with the third voltage V3 such that the amplifier 220 controls the second current I2 to maintain a constant value in negative feedback. In this manner, the first and second current sources 210 and 211 and the amplifier 220 comprise a negative current feed-back loop.

Such a negative current feed-back loop may be implemented differently. For example, the load terminal voltage V2 may be applied at the negative input of the amplifier 220, and the reference voltage Vref may be applied at the positive input of the amplifier 220. In that case, the second current source 211 is designed to generate the second current I2 that is proportional to the voltage V3 output by the amplifier 220. Thus, when the second current I2 increases, the load terminal voltage V2 increases, and the voltage V3 output by the amplifier 220 decreases. As a result, the first and second currents I1 and I2 are maintained to be constant with values proportionally dependent on the reference voltage Vref.

The charge voltage regulator 230 includes a third current source 231, a voltage-to-current converter 232, and a state machine 233. The charge voltage regulator 230 limits a battery charging terminal voltage V1 at the battery charging terminal 251 to a battery regulation voltage.

The state machine 233 determines a charge mode of the battery charger 200 to be in one of a constant current mode or a constant voltage mode. In the constant current mode, the third current I3 generated by the third current source 231 is zero so that the charge current I1 may have a constant value. When the battery 250 is charged by the charge current I1, the battery charging terminal voltage V1 increases. When the battery charging terminal voltage V1 reaches the battery regulation voltage, the state machine 233 sets the charge mode of the battery charger 200 to the constant voltage mode.

In the constant voltage mode, the third current I3 of the third current source 231 is used for controlling the second current I2 of the second current source 211. That is, the load terminal voltage V2 is substantially same as the reference voltage Vref with a sum of the second and third currents I2 and I3 being substantially constant. Thus, when the third current I3 increases, the second current I2 decreases.

When the battery charging terminal voltage V1 reaches the battery regulation voltage, a current outputted from the voltage-to-current converter 232 increases in the constant voltage mode. The third current source 231 generates the third current I3 to mirror the current from the voltage-to-current converter 232. Thus, in the constant voltage mode, the third current I3 increases to decrease the second current I2 such that the battery charging terminal voltage V1 is limited to the battery regulation voltage.

The device 240 for detecting the existence/non-existence of a battery includes a voltage level detector 243, a battery detector 242, and a regulation voltage controller 241. The voltage level detector 243 detects the battery charging terminal voltage V1 and compares such a voltage V1 with a battery detection reference voltage to generate a battery detection signal DET_BATT to the battery detector 242. When the battery charging terminal voltage V1 is greater than the battery detection reference voltage, the DET_BATT signal is activated to a logic high state that is at the logic low state otherwise.

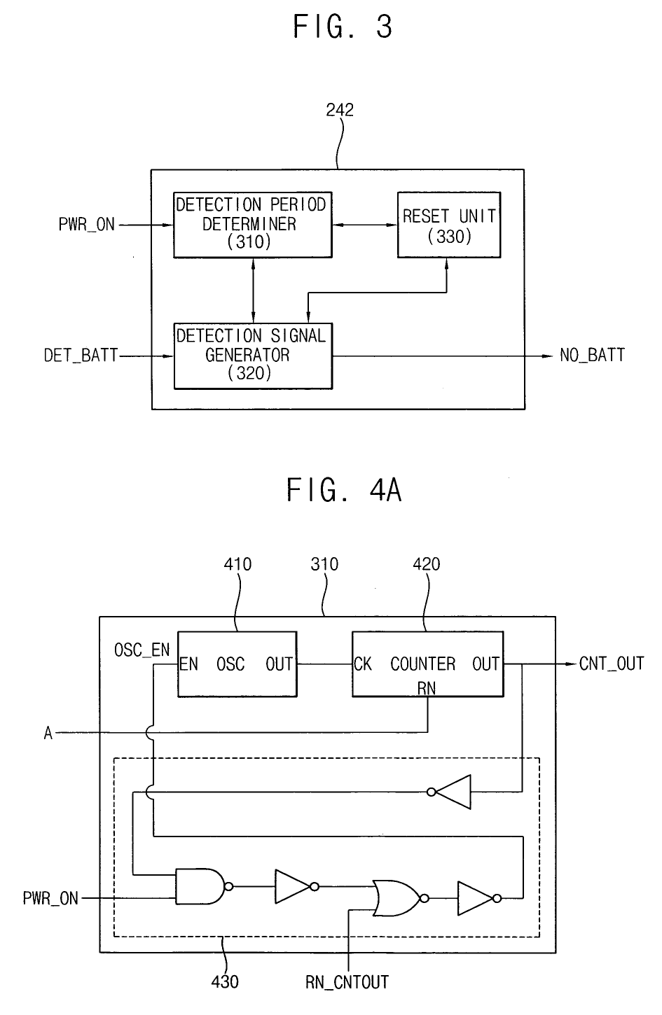

The battery detector 242 generates a battery existence/non-existence indication signal NO_BATT to the regulation voltage controller 241 based on the DET_BATT signal when a detection period is terminated. A more detailed description of the battery detector 242 follows later herein with reference to FIG. 3.

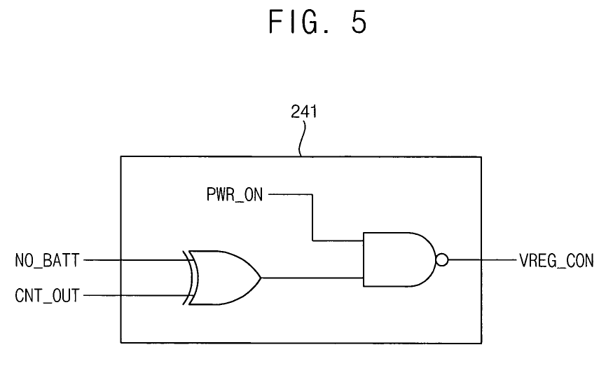

FIG. 5 shows an example implementation of the regulation voltage controller 241 that sets the battery regulation voltage based on the NO_BATT signal. For example, when the NO_BATT signal indicates an existence of a battery connected to the battery charging terminal 251, the regulation voltage controller 241 sets the battery regulation voltage to a normal mode value. Alternatively, when the NO_BATT signal indicates a non-existence of any battery at the battery charging terminal 251, the regulation voltage controller 241 sets the battery regulation voltage to a test mode value that is higher than the normal mode value.

FIG. 3 shows a block diagram of the battery detector 242 according to an example embodiment of the present invention. Referring to FIG. 3, the battery detector 242 includes a detection period determiner 310, a detection signal generator 320, and a reset unit 330.

The detection period determiner 310 determines a termination time point of a predetermined time period (i.e., a detection time period) from when a PWR_ON signal that is input to the detection period determiner 310 becomes activated to the logic high state. When such a detection period is terminated, the detection period determiner 310 activates a detection period termination signal.

The detection signal generator 320 generates the NO_BATT signal based on the DET_BATT signal when the detection period is terminated. The reset unit 330 generates a reset signal to the detection period determiner 310 that uses the reset signal for determining a termination time point from another detection period when a battery is removed from the battery charger during charging in the normal mode.

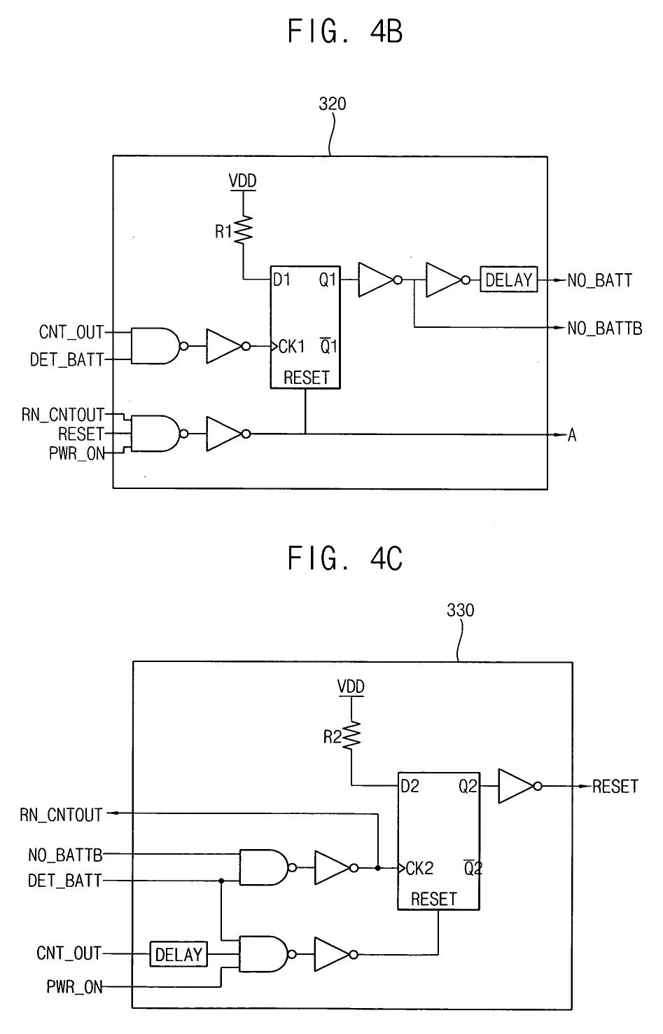

FIGS. 4A, 4B, and 4C show circuit diagrams of the detection period determiner 310, the detection signal generator 320, and the reset unit 330, according to an example embodiment of the present invention. Referring to FIG. 4A, the detection period determiner 310 includes an oscillator 410, a counter 420, and an oscillator enabling signal generating circuit 430.

The oscillator enabling signal generating circuit 430 generates an oscillation enable signal OSC_EN based on a PWR_ON signal. When power is initially applied to the battery charger 200, a battery charging voltage VCHG (which is a high power source voltage in FIG. 2) ramps up. When the VCHG voltage exceeds a predetermined value, the PWR_ON signal is activated to the logic high state such that the PWR_ON signal indicates whether power is provided to the battery charger 200. The activated PWR_ON signal activates the OSC_EN to the logic high state.

When the OSC_EN signal is at the logic high state, the oscillator 410 outputs an oscillation signal having a predetermined frequency. The counter 420 counts the oscillation signal a predetermined number of cycles to activate a CNT_OUT signal to the logic high state after counting the oscillation signal the predetermined number of cycles. For example, when the oscillation signal has a frequency of about 100 KHz and the counter 420 counts the oscillation signal 10,000 times, the counter 420 activates the CNT_OUT signal to the logic high state after a predetermined detection time period of about 0.1 seconds.

In that case, the activated CNT_OUT signal indicates a termination time point of the predetermined detection time period, and the OSC_EN signal is set to the logic low state at that time point. When the OSC_EN signal is set to the logic low state, the oscillator 410 does not output any oscillation signal.

When the battery 250 is removed from the battery charger 200 while being charged, the OSC_EN signal is activated to the logic high state based on an RN_CNTOUT signal, and the counter 420 is reset by an A signal. Thus in that case also, the oscillator 410 outputs the oscillation signal that is counted by the counter 420 the predetermined number of cycles at which point the counter 420 activates the CNT_OUT signal to the logic high state.

The A signal and the RN_CNTOUT signal are generated by the detection signal generator 320 and the reset unit 330 of FIGS. 4B and 4C, respectively. Referring to FIG. 4B, the detection signal generator 320 includes a first D flip-flop and a plurality of first logic gates.

Initially, the NO_BATT signal is at the logic low state. A signal applied at a first input terminal D1 of the first D flip-flop is set to the logic high state, and a first output signal at a first output terminal Q1 is activated to the logic high state at a rising edge of a signal applied at a first clock terminal CK1. When the first output signal at the output terminal Q1 is at the logic high state, the NO_BATT signal is at the logic high state, and a NO_BATTB signal, which has an opposite phase to that of the NO_BATT signal, is at the logic low state. When both of the CNT_OUT signal and the DET_BATT signal are activated to the logic high state, the signal applied at the first clock terminal CK1 is activated to the logic high state from the logic low state.

The first D flip-flop is reset by the RN_CNTOUT signal and the PWR_ON signal generated by the reset unit 330 of FIG. 4C. Referring to FIG. 4C, the reset unit 330 includes a second D flip-flop and a plurality of second logic gates. A signal set to the logic high state is applied at an input terminal D2 of the second D flip-flop. The RESET signal is initially set to the logic high state because an output signal generated at an output terminal Q2 of the second flip flop of FIG. 4C is at the logic low state.

The RESET signal becomes set to the logic low state at a rising edge of a signal applied at a clock terminal CK2 of the second flip flop of FIG. 4C. When both of the NO_BATTB signal and the DET_BATT signal are activated to the logic high state, the signal applied at the clock terminal CK2 rises to the logic high state from the logic low state. While the battery 250 is charged, the NO_BATTB signal is at the logic high state, and the DET_BATT signal is at the logic low state.

When the battery 250 is removed from the battery charger 200 while being charged, the DET_BATT signal is activated to the logic high state from the logic low state. In that case, the RN_CNTOUT signal is activated to the logic high state from the logic low state. Referring now to FIG. 4B, the RESET signal is at the logic high state, and the A signal is activated to the logic high state from the logic low state when the RN_CNTOUT signal is activated. When the A signal is activated to the logic high state, the counter 420 of FIG. 4A is reset, and the CNT_OUT signal falls to the logic low state from the logic high state.

When the DET_BATT signal is activated to the logic high state, the signal applied at the clock terminal CK2 of the second flip flop of FIG. 4C is activated to the logic high state from the logic low state. Thus, the RESET signal falls to the logic low state from the logic high state. When the DET_BATT signal is activated to the high state, the CNT_OUT signal falls to the logic low state from the logic high state so that the second D flip-flop is reset after a time delay. Thus, the RESET signal is activated again to the logic high state after the time delay.

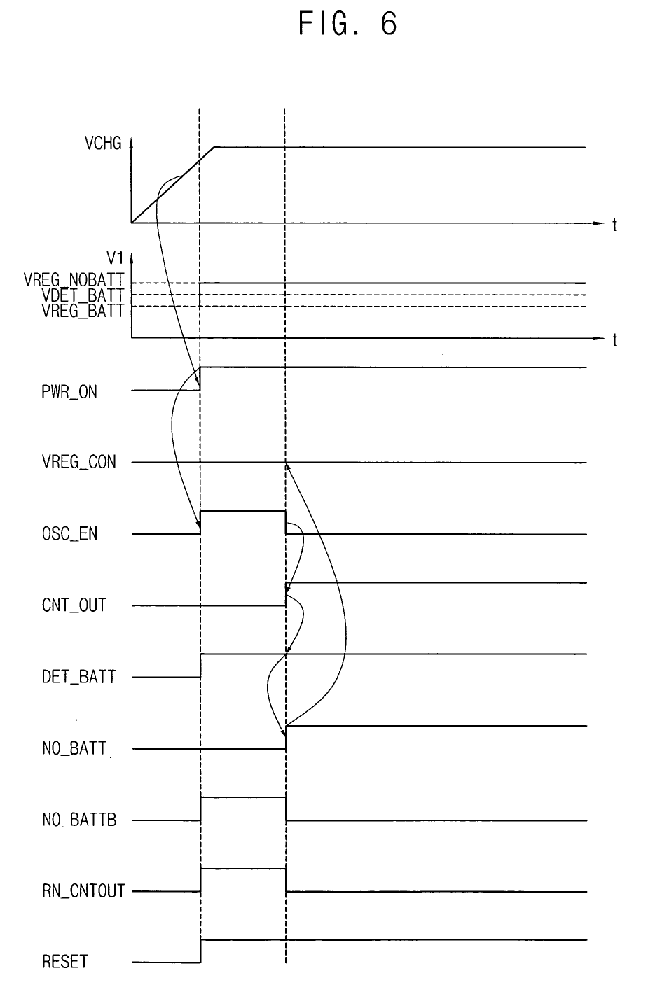

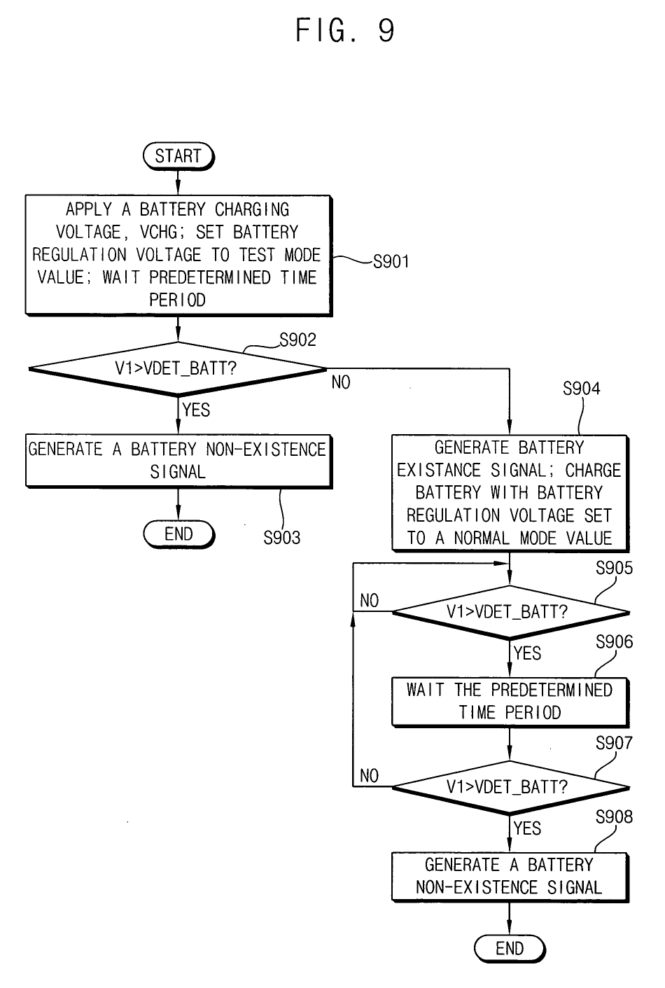

Operation of the battery charger 200 of FIG. 2 is now described in reference to the timing diagrams of FIGS. 6, 7, and 8. FIG. 9 shows as flow-chart of steps during operation of the battery charger 200 of FIG. 2.

FIG. 6 is a timing diagram of the signals in the battery charger 200 of FIG. 2 when the non-existence of a battery is detected. Referring to FIGS. 2 and 6, when power is initially applied to the battery charger 200, the applied battery charging voltage VCHG initially increases as a ramp (step S901 of FIG. 9). When the battery charging voltage VCHG exceeds a predetermined value, the PWR_ON signal is activated to the logic high state. The battery charger 200 is operated initially in a test mode when the battery regulation voltage is set to the higher test mode value, VREG_NOBATT (step S901 of FIG. 9).

When the PWR_ON signal is activated to the logic high state, the OSC_EN signal is activated to the logic high state. In that case, the detection period determiner 310 of FIG. 3 within in the battery detector 242 outputs the oscillation signal that is counted by the counter 420 for the predetermined number of cycles at which time the CNT_OUT signal is activated to the logic high state. At that time point, the predetermined detection time period after the PWR_ON signal has been activated is terminated (step S901 of FIG. 9).

At such a time point, the battery detector 242 determines whether a battery is connected to the battery charging terminal 251 from the DET_BATT signal generated by the voltage level detector 243. At such a time point, the DET_BATT signal is set to the logic high state indicating a nonexistence of the battery 250, or the DET_BATT signal is set to the logic low state indicating an existence of a battery within the battery charger 200.

The voltage level detector 243 compares the battery charging terminal voltage V1 with the battery detection reference voltage VDET_BATT to generate the DET_BATT signal (step S902 of FIG. 9). The battery detection reference voltage VDET_BATT is higher than the normal mode value (i.e., VREG_BATT in FIG. 6) of the battery regulation voltage but lower than the battery charging voltage VCHG, in an example embodiment of the present invention. In addition, the battery detection reference voltage VDET_BATT is lower than the test mode value (i.e., VREG_NOBATT in FIG. 6) of the battery regulation voltage, in an example embodiment of the present invention.

When a battery is not connected to the battery charging terminal 251, the battery charging terminal voltage V1 increases to substantially the battery charging voltage VCHG until the charge current I1 is zero. In that case, the battery charging terminal voltage V1 exceeds the battery detection reference voltage VDET_BATT (step S902), and the DET_BATT signal is activated to the logic high state (which is a battery non-existence signal) to indicate a non-existence of a battery in the battery charger 200 (step S903 of FIG. 9).

When the DET_BATT signal is activated to the logic high state, a regulation control signal VREG_CON is maintained in the logic low state by the regulation voltage controller 241. When the VREG_CON signal is at the logic low state, the battery regulation voltage is maintained at the higher test mode value VREG_NOBATT.

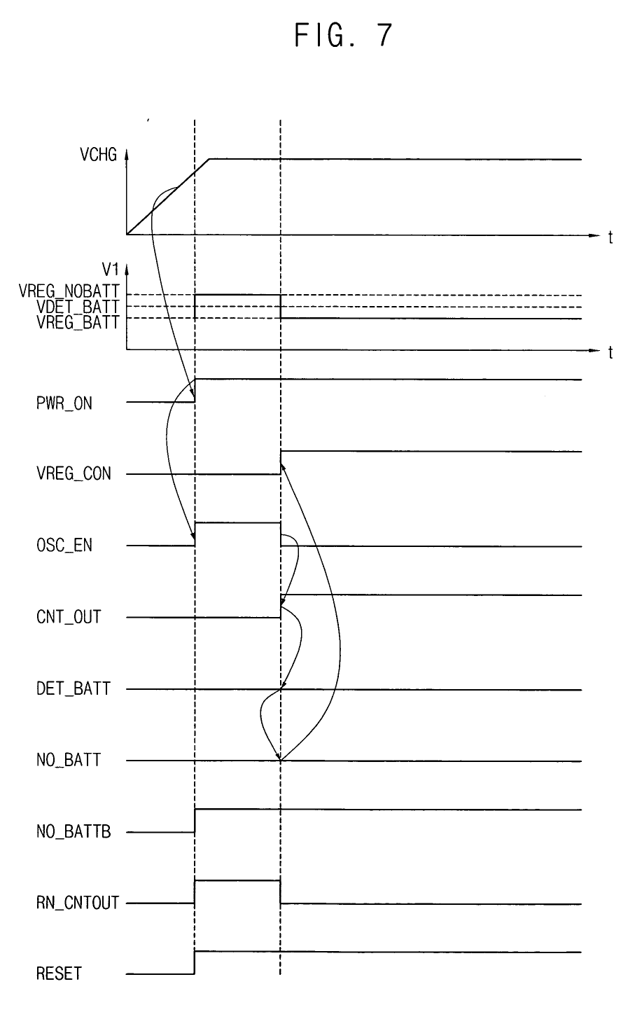

FIG. 7 is a timing diagram of the signals in the battery charger 200 of FIG. 2 when the existence of the battery 250 is detected. Referring to FIGS. 2 and 7, when power is initially applied to the battery charger 200, the applied battery charging voltage VCHG initially increases as a ramp (step S901 of FIG. 9). When the battery charging voltage VCHG exceeds a predetermined value, the PWR_ON signal is activated to the logic high state. The battery charger 200 is operated initially in the test mode when the battery regulation voltage is set to the higher test mode value, VREG_NOBATT (step S901 of FIG. 9).

When the PWR_ON signal is activated to the logic high state, the OSC_EN signal is activated to the logic high state. In that case, the detection period determiner 310 of FIG. 3 within in the battery detector 242 outputs the oscillation signal that is counted by the counter 420 for the predetermined number of cycles at which time the CNT_OUT signal is activated to the logic high state. At that time point, the predetermined detection time period after the PWR_ON signal has been activated is terminated (step S901 of FIG. 9).

At such a time point, the voltage level detector 243 compares the battery charging terminal voltage V1 with the battery detection reference voltage VDET_BATT to generate the DET_BATT signal (step S902 of FIG. 9). During the short charging time of the predetermined detection time period, the battery charging terminal voltage V1 does not exceed the normal mode value VREG_BATT of the battery regulation voltage. Thus, the battery charging terminal voltage V1 is not greater than the battery detection reference voltage VDET_BATT after the short predetermined detection time period (step S902 of FIG. 9) if the battery 250 is connected to the battery charging terminal 251.

In that case, the DET_BATT signal is maintained in the logic low state (which is a battery existence signal) indicating existence of the battery 250 connected to the battery charging terminal 251 (step S904 of FIG. 9). In addition, when the DET_BATT signal is at the logic low level, the VREG_CON signal is activated to the logic high state by the regulation voltage controller 241. When the VREG_CON signal is at the logic high state, the battery regulation voltage is set to the lower normal mode value VREG_BATT (step S904 of FIG. 9). Thus, the battery 250 is then charged with the battery charging terminal voltage V1 being limited to the battery regulation voltage having the lower normal mode value VREG_BATT (step S904 of FIG. 9).

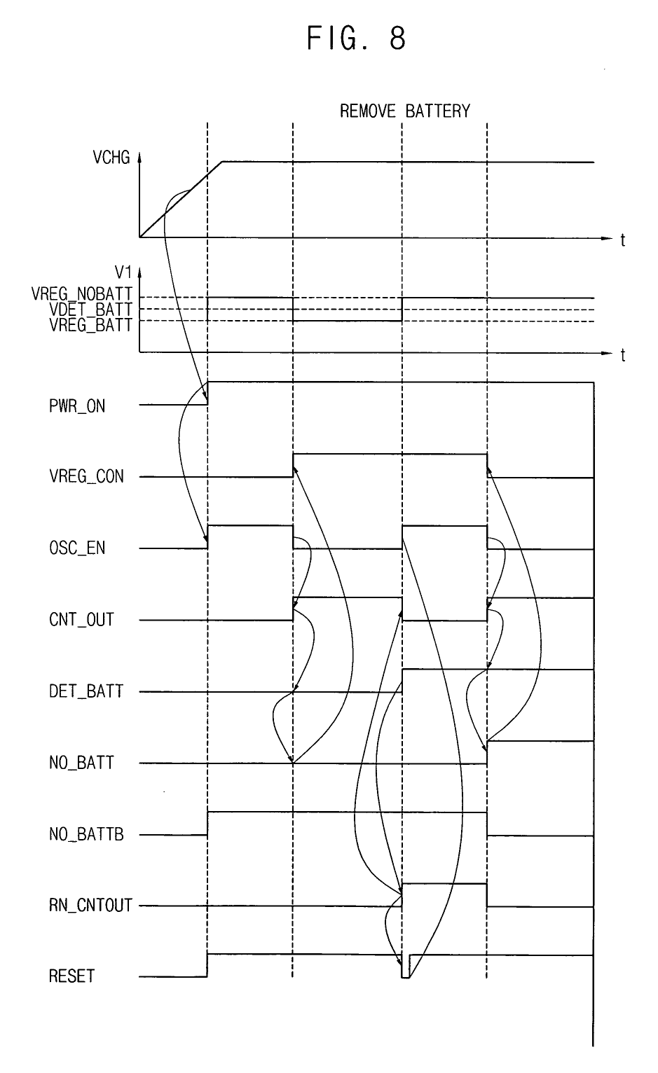

FIG. 8 is a timing diagram of the signals in the battery charger 200 of FIG. 2 when the removal of the battery 250 during charging is detected. Referring to FIGS. 2, 7, and 8, the signals in FIGS. 7 and 8 are similar up to step S904 of FIG. 9 when the battery is being charged with the battery regulation voltage having the lower normal mode value VREG_BATT.

In that case, the battery charger 200 charges the battery 250 first in the constant current mode before the battery charging terminal voltage V1 reaches the VREG_BATT voltage. After the battery charging terminal voltage V1 reaches the VREG_BATT voltage, the battery charger 300 charges the battery 250 in the constant voltage mode such that the battery charging terminal voltage V1 is limited to the battery regulation voltage VREG_BATT.

When the battery 250 is removed while being charged, the battery charging terminal voltage V1 increases toward the battery charging voltage VCHG. Thus, the battery charging terminal voltage V1 becomes greater than the battery detection reference voltage VDET_BATT (step S905 of FIG. 9) indicating an irregular time point. In that case, the DET_BATT signal is activated to the logic high state, and the RN_CNTOUT signal is in turn activated to the logic high state to initialize the counter 420 of the detection period determiner 310 when the CNT_OUT signal is set to the logic low state.

Subsequently, the RN_CNTOUT signal is set to the logic low state and is maintained in the logic low state for a while such that the OSC_EN signal is activated to the logic high state. In that case, the detection period determiner 310 of FIG. 3 within in the battery detector 242 outputs the oscillation signal that is counted by the counter 420 for the predetermined number of cycles at which time the CNT_OUT signal is activated to the logic high state. At that time point, the predetermined detection time period after the irregular time point when the DET_BATT had been activated is terminated (step S906 of FIG. 9).

Also at that time point, if the battery charging terminal voltage V1 is still greater than the battery detection reference voltage VDET_BATT (step S907 of FIG. 9), the DET_BATT is still activated to the logic high state (step S908 of FIG. 9) to indicate that the battery has been removed (step S908 of FIG. 9). In addition in that case, the VREG_CON signal from the regulation voltage controller 241 is set to the logic low state such that the battery regulation voltage is set to the higher test mode value VREG_NOBATT.

In this manner, steps S905, S906, S907, and S908 of FIG. 9 represent monitoring for the removal of the battery during charging of the battery within the battery charger 200.

According to the present invention, the battery charger 200 detects for the existence/non-existence of a battery without an additional external device or pin. In addition, the battery charger 200 detects for the removal of the battery during charging of the battery.

The above-described device for detecting the existence/non-existence of a battery or the above-described battery charger may be formed such that each component of the device or the battery charger may include sub-components or a plurality of the components of the device or the battery charger may be part of a system. Additionally, a portion of the functions of one component of the device or the battery charger may be handled by another component.

While the example embodiments of the present invention and their advantages have been described in detail, it should be understood that various changes, substitutions and alterations may be made herein without departing from the scope of the invention.

The present invention is limited only as defined in the following claims and equivalents thereof.

What is claimed is:

1. A method for detecting a battery within a charger, the method comprising:
A. charging a battery charging terminal limited to a battery regulation voltage that is initially set to a test mode value;
B. generating a battery existence signal if a battery charging terminal voltage is not greater than a battery detection reference voltage at an end of a predetermined time period from a power-on of the charger; and
C. charging the battery charging terminal limited to the battery regulation voltage set to a normal mode value if the battery existence signal is generated.

2. The method of claim 1, further comprising:
generating a battery non-existence signal if the battery charging terminal voltage is greater than the battery detection reference voltage at the end of the predetermined time period.

3. The method of claim 1, further comprising:
monitoring the battery charging terminal voltage after the battery regulation voltage is set to the normal mode value for detecting removal of the battery.

4. The method of claim 3, further comprising:
detecting an irregular time point when the battery charging terminal voltage becomes greater than the battery detection reference voltage; and
generating a battery non-existence signal if the battery charging terminal voltage is greater than the battery detection reference voltage at the end of the predetermined time period from the irregular time point.

5. The method of claim 1, wherein the test mode value is greater than the normal mode value for the battery regulation voltage, and wherein the battery detection reference voltage is higher than the normal mode value of the battery regulation voltage and lower than a high power source voltage.

6. The method of claim 1, further comprising:
controlling a level of current flowing to the battery charging terminal with feedback control for charging the battery charging terminal.

7. The method of claim 1, further comprising:
generating an oscillation signal;
counting the oscillation signal a predetermined number of cycles; and
activating a detection termination signal after the oscillation signal is counted the predetermined number of cycles for indicating the end of the predetermined time period.

8. A device for detecting a battery within a charger, the device comprising:
a regulation voltage controller for limiting a battery charging terminal voltage to a battery regulation voltage that is initially set to a test mode value; and
a battery detector for generating a battery existence signal if a battery charging terminal voltage is not greater than a battery detection reference voltage at an end of a predetermined time period from a power-on of the charger,
wherein the regulation voltage controller limits the battery charging terminal voltage to the battery regulation voltage set to a normal mode value if the battery existence signal is generated.

9. The device of claim 8, wherein the battery detector generates a battery non-existence signal if the battery charging terminal voltage is greater than the battery detection reference voltage at the end of the predetermined time period.

10. The device of claim 8, wherein the battery detector detects for removal of the battery after the battery regulation voltage is set to the normal mode value.

11. The device of claim 10, further comprising:
a reset unit for detecting an irregular time point when the battery charging terminal voltage becomes greater than the battery detection reference voltage,
wherein the battery detector generates a battery non-existence signal if the battery charging terminal voltage is greater than the battery detection reference voltage at the end of the predetermined time period from the irregular time point.

12. The device of claim 8, wherein the test mode value is greater than the normal mode value for the battery regulation voltage, and wherein the battery detection reference voltage is higher than the normal mode value of the battery regulation voltage and lower than a high power source voltage.

13. The device of claim 8, further comprising:
a voltage level detector for comparing the battery charging terminal voltage and the battery detection reference voltage.

14. The device of claim 8, further comprising:
an oscillator for generating an oscillation signal;
a counter for counting the oscillation signal a predetermined number of cycles; and
a detection period determiner for activating a detection termination signal after the oscillation signal is counted the predetermined number of cycles for indicating the end of the predetermined time period.

15. A battery charger comprising:
a current feed-back loop for controlling a level of a current flowing to the battery charging terminal;
a regulation voltage controller for limiting a battery charging terminal voltage to a battery regulation voltage that is initially set to a test mode value; and
a battery detector for generating a battery existence signal if a battery charging terminal voltage is not greater than a battery detection reference voltage at an end of a predetermined time period from a power-on of the charger,
wherein the regulation voltage controller limits the battery charging terminal voltage to the battery regulation voltage set to a normal mode value if the battery existence signal is generated.

16. The battery charger of claim 15, further comprising:
a charge voltage regulator that maintains the current flowing to the battery charging terminal at a constant level in a current mode when the battery charging terminal voltage is less than the battery regulation voltage,
wherein the charge voltage regulator decreases the current flowing to the battery charging terminal when the battery charging terminal voltage reaches the battery regulation voltage.

17. The battery charger of claim 15, wherein the battery detector generates a battery non-existence signal if the battery charging terminal voltage is greater than the battery detection reference voltage at the end of the predetermined time period.

18. The battery charger of claim 15, wherein the battery detector detects for removal of the battery after the battery regulation voltage is set to the normal mode value.

19. The battery charger of claim 18, further comprising:
a reset unit for detecting an irregular time point when the battery charging terminal voltage becomes greater than the battery detection reference voltage,
wherein the battery detector generates a battery non-existence signal if the battery charging terminal voltage is greater than the battery detection reference voltage at the end of the predetermined time period from the irregular time point.

20. The battery charger of claim 15, wherein the test mode value is greater than the normal mode value for the battery regulation voltage, and wherein the battery detection reference voltage is higher than the normal mode value of the battery regulation voltage and lower than a high power source voltage.

21. The battery charger of claim 15, further comprising:
an oscillator for generating an oscillation signal;
a counter for counting the oscillation signal a predetermined number of cycles; and
a detection period determiner for activating a detection termination signal after the oscillation signal is counted the predetermined number of cycles for indicating the end of the predetermined time period.
